(19) United States
(12) Patent Application Publication
(10) Pub. No.: US 2012/0278003 A1
(43) Pub. Date: Nov. 1, 2012

(54) Wireless Data Transmission System for Metal Processing

(76) Inventors: Paul A. Turner, Milwaukee, WI (US); David G. Janu, West Allis, WI (US)

(21) Appl. No.: 13/095,191

(22) Filed: Apr. 27, 2011

(51) Int. Cl. G06F 19/00

(52) U.S. Cl. 702/23; 702/1

(57) ABSTRACT

Apparatus is provided for measurement and display of at least one characteristic of molten metal contained in a metal processing vessel that includes a probe supported by an immersion end of a lance. The probe is adapted to be submerged in the molten metal to obtain data in analog form identifying at least one characteristic of the metal while a module is connected to an end of the lance opposite from the immersion end. The module contains electronic circuitry for receiving analog data and for converting the analog data into digital form, and the module also contains electronic circuitry for transmitting digital data to a remotely located receiving device which may be a microprocessor used in readout and control of the metallurgical process.

### BACKGROUND OF THE INVENTION

The invention relates to monitoring and control systems for molten metal processing, particularly for use in steel mills for the use in conjunction with sensor probes in molten steel. The system of the invention eliminates the wires that in prior systems transmit the signals between an immersion probe having sensors used to measure temperature, oxygen and/or carbon content in the steel and a remote readout instrument. Likewise, the system eliminates wires between other components such as signal lights and remote data posting boards. The benefits obtained include improved safety, reduced costs, increased accuracy and reliability of measurements and increased support pole life. The wireless system can be installed at any locations or vessels where conventional measurement probes and associated poles are used.

Since the inception of measurements in liquid steel with temperature, oxygen and carbon probes, test results have been transmitted to readout instruments by an insulated electrical cord or cable. As a result, constant attention to the cables and connectors, which is manpower intensive and not always successful, has often interfered with process efficiency.

The invention eliminates these problems by providing a small, rugged, battery-powered, wireless data acquisition module on the end of an immersion pole. The module is preferably formed of a durable material, preferably metal such as aluminum, but a tough plastic material could also be used. This module converts analog signals from the probes to digital format and wirelessly transmits the digital signals to the control monitoring instruments. Thus, rapid processing of sample data is accomplished. In addition, wireless communication is provided between the instrument, signal lights and display panels or “scoreboards” which display measurement status and the measurement results.

The system of the invention additionally provides a number of features that have been heretofore lacking in previous systems. Among the novel features is a keyed, quick disconnect coupling, such as a threaded type, between the control module and a support pole or lance. This feature is important in an environment where the elevated temperatures may consume the support pole causing unacceptable delay in replacement of a pole and/or probe. Also, the module provided by the invention can readily be moved to another location if needed. Additionally, the module is powered by a removable, rechargeable battery pack. Operator feedback lights are provided to alert an operator to conditions such as “power on/off,” low battery, and signal strength.

The module of this invention includes software that provides a discovery mode that enables it to associate with parent instrumentation at other testing locations in the work area in order to seamlessly switch out one unit with another in cases where a spare unit is required. A protective handle around the module provides protection against impacts from any direction with flat surfaces.

Yet another aspect of the invention is the provision of a portable supplemental or “add-on” unit that can be placed in the work area in a position wherein the operator, in contrast with prior art display boards, does not have to turn around and thus take his eyes off of a probe immersion. Thus, the invention provides important safety and process control accuracy improvements. Control of new and even temporary process installations is thus facilitated.

In applications where immersion probe measurements of the molten metal are not involved, the invention readily works in conjunction with semi-permanent measuring devices and thus eliminates the need for signal transmission wires to a remote readout instrument. Examples of such devices are those given in U.S. Pat. Nos. 5,071,258, 5,209,571, 5,388,908, and U.S. patent application Ser. No. 12/575,105. An example of yet another device that the present invention is compatible with is that given in U.S. patent application Ser. No. 12/706,998, a device used for continuous temperature measurement in a steel making ladle with a porous plug. The invention interfaced with said device allows for continuous measurements of the molten steel remotely at any point throughout the steel making process, thus providing steel makers a high level of temperature monitoring and control.

### Prior Art Wired Systems

Measurements using temperature, oxygen and carbon probes in liquid steel and iron all have a common factor: a cable transmits signal(s), usually analog, from the probe to the read-out instrument in a monitoring or control station. The use of such insulated cables has posed numerous problems in steelmaking or similar metal processing operations. Among these are: tripping hazards and temporary cable storage problems which have been a source of complaints and cost. Also, the alloy composition of the wires in the cable and contacts in associated connectors make the wired systems expensive to install and maintain. Moreover, electromagnetic interference (EMI) and radio frequency interference (RFI) from high-voltage sources, such as motors, power lines, EAFs and LMFs can cause incorrect signals to be transmitted to the readout instruments, the potential for such interference increasing as the transmission distance increases. Further, the formation of unwanted inadvertent thermocouple junctions caused by improper alloy use at any point along the transmission path also leads to incorrect measurements. All wires in the cable must be precisely and securely connected to the correct junctions, since incorrect wiring or loose connections can cause constant or intermittent signal problems. Running these wires through conduits for protection and work area cleanliness is expensive and manpower-intensive. The dirt, water, heat, smoke and steel/slag splash, normal facts of life in a steel mill, tend to become signal-altering coatings and residues within electrical connectors throughout a wired system. Faulty measurements and incorrect information can be caused by a cable that has been cut by scrap, burned by steel/slag splash, run over by mobile equipment or tangled in equipment. All these potential problems can adversely affect the accuracy of the measurement or delay or prevent a successful measurement. In addition, only a minor disturbance in the transmission wires and connections can cause significant errors in the determination of temperature, oxygen and thermal arrest carbon.

Although digital signaling equipment has been used in many applications throughout various industries, cables remain standard, in spite of the foregoing problems, throughout steelmaking monitoring applications.

The innovative system of the present invention includes a small, rugged housing forming a removable, battery-powered data acquisition module, conveniently attached to an end of an immersion pole and which houses a circuit board, wireless transmitter and rechargeable battery. The invention further provides a novel computer readout instrument with a wireless receiving modem that receives digital data from the immersion pole. The circuitry in the wireless module on the immersion pole converts analog signals from the temperature, oxygen or carbon probes to digital format and sends the data to a receiver in the control instrument or computer. The computer, through proprietary software, then reads the signals, analyzes the data, controls signal lights, displays the output curves and calculates measurement results. The software also provides extensive data management and communication for wireless signal lights and “scoreboard” displays.

### DRAWINGS

The invention will be set forth in greater detail with reference to the accompanying drawings, wherein:

FIG. 1 is a hardware block diagram illustrating the invention;

FIGS. 1A and 1B, together, are a block diagram showing the software logic of the system;

FIG. 1C is a block diagram showing a continuous data transmission and reception mode used in conjunction with the invention;

FIG. 2 is a block diagram showing a discovery mode used in conjunction with the invention;

FIGS. 2A and 2B, together, are a block diagram showing the data display and light set operation;

FIG. 3 is a fragmentary perspective view of a module used in practice of the invention with a support handle broken away;

FIG. 4 is a fragmentary side view of the module of FIG. 3;

FIG. 5 is a perspective view of the module with a battery compartment cover open and battery removed from the compartment; and,

FIG. 6 is a perspective view of an add-on, portable unit adapted to be used in conjunction with invention.

### DETAILED DESCRIPTION

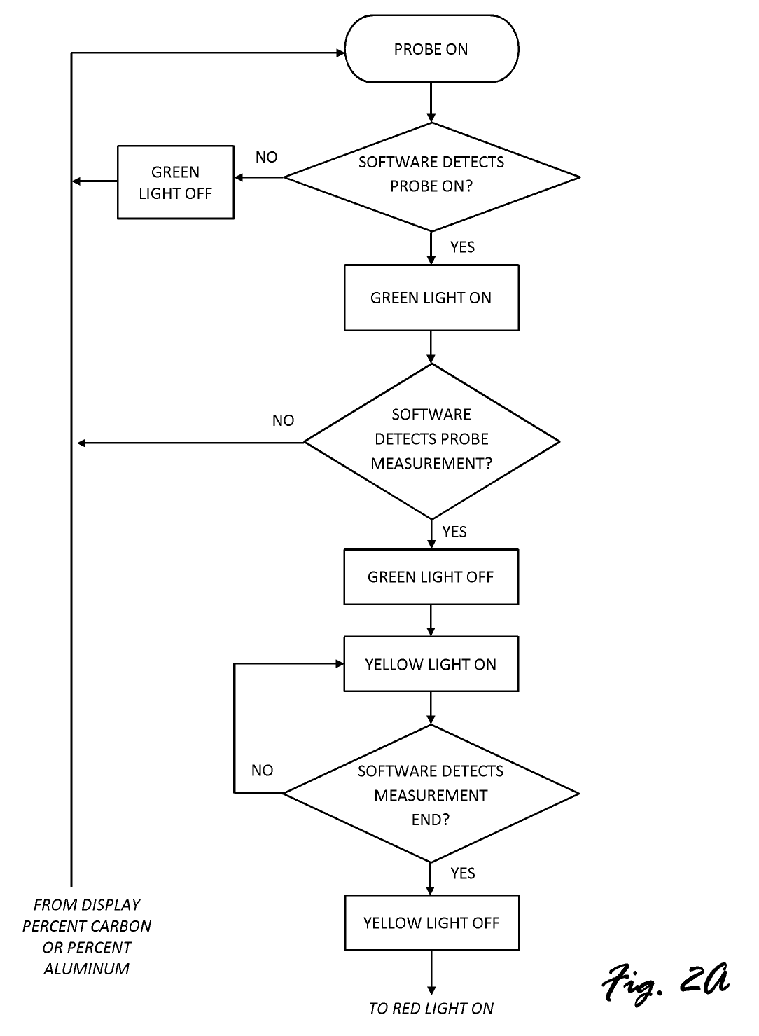

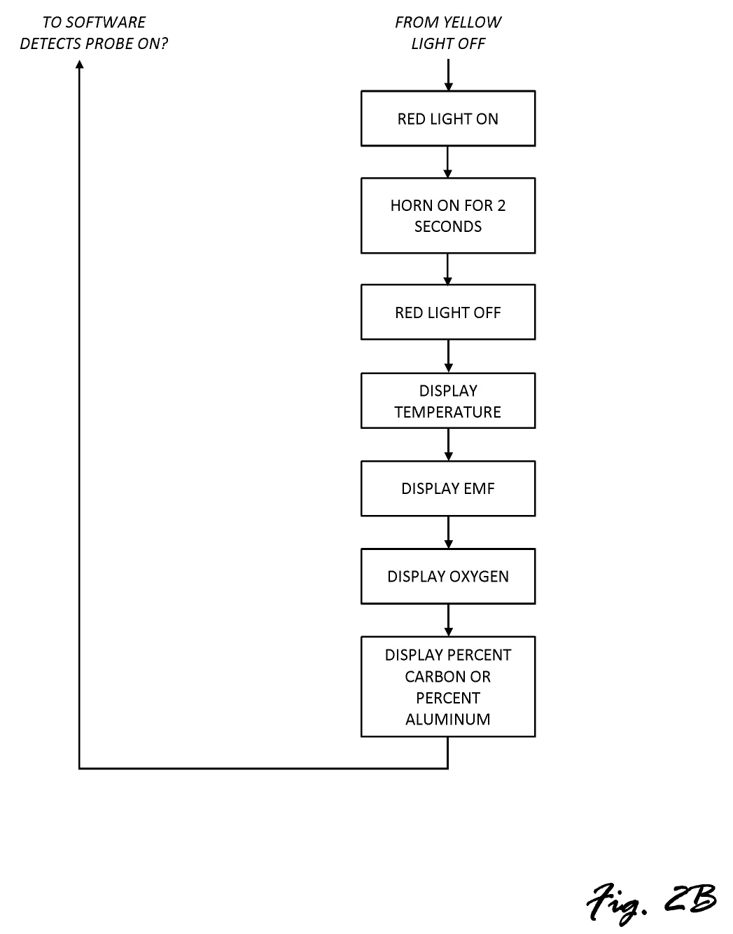

Referring to FIGS. 3 and 4, there is seen a data acquisition module 10 used in the practice of the invention. Protective handle 12 having a knurled steel or elastomeric grip 14 is affixed to the end of a lance 20 and is configured so as to shield module 10 against damage in the event of the module being dropped or struck by another object. Module 10 is supported on lance 20 by means of a threaded quick disconnect connector which includes a female portion 16 and a male portion 18. A series of lights 22, 23 and 24 on module 10 can provide information as to the status of the circuitry carried within the module 10. In the illustrated embodiment, a series of lights 22 provide information regarding the strength of a wireless signal while another light 23 indicates whether the module 10 is powered up and light 24 is a low battery indicator. The arrangement of these lights is a matter of choice for the equipment designer.

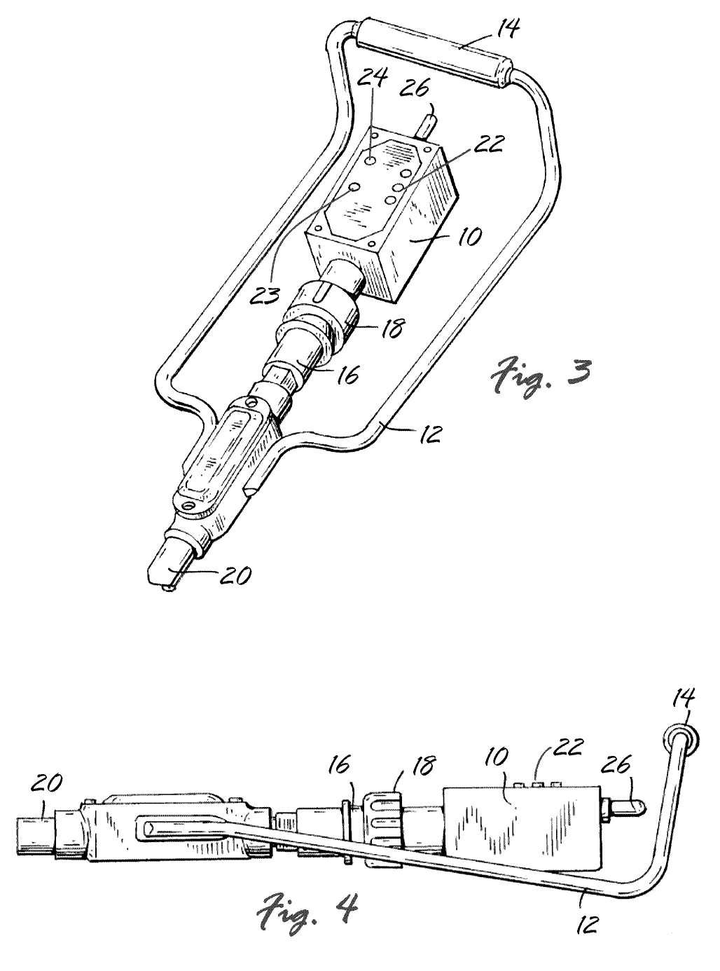

An antenna 26 is provided for sending or receiving digital signals. Referring to FIG. 5, a rechargeable battery 28 is removable by opening of a battery compartment door 27. Also best seen in FIG. 5, pin connectors 19 are provided in order to furnish a direct connection via lance 20 with the circuitry of the sensors contained in an immersible probe at the immersible end of the lance 29. Often the sensors include an oxygen probe, a carbon content probe, and a thermocouple, etc. The sensors provide analog signals which are transmitted to the instruments, readout and/or control apparatus. In accord with the invention, the module 10 is provided with circuitry that converts the analog signals into a digital format that is readily transmitted wirelessly to readout and control instruments in accordance with known technology. A microprocessor is generally provided for this purpose.

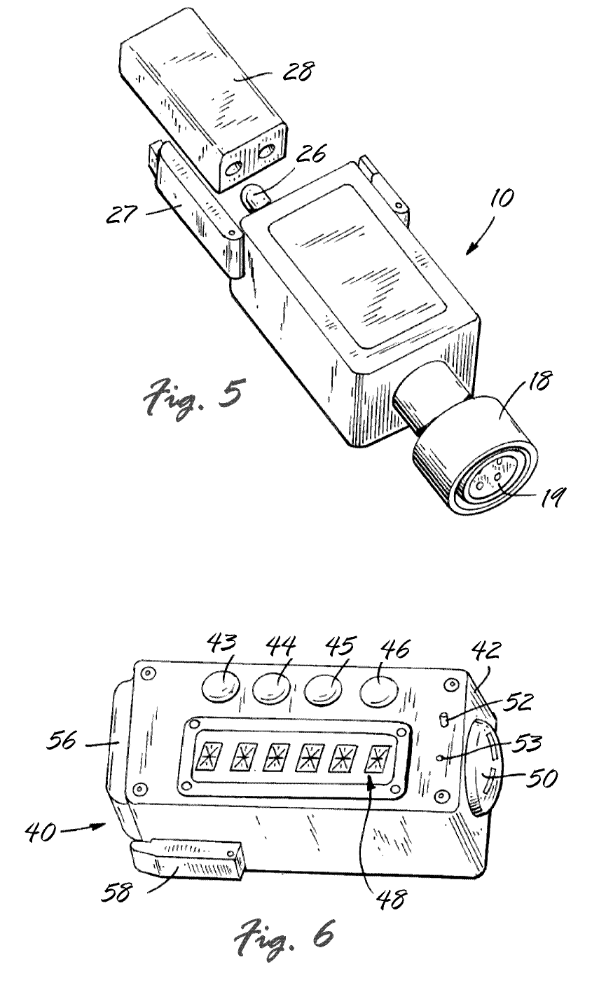

As shown in FIG. 6, the invention also includes a portable display unit 40. An aluminum or similar housing is provided to carry various control lights. In the illustrated embodiment, for example, a light 43 may be green and signify that the probe is electrically connected to the sensor lance. Similarly, light 44 may be blue and indicate, for example, that an associated carbon probe is electrically connected to the sensor lance 20. Light 45 may be yellow and may indicate to the operator that a measurement is in progress, while 46 may be red and indicate that the measurement has been concluded. Control buttons are also provided, button 52 being provided to activate power to the unit and button 53 to activate a discovery function, described below.

A readout display 48 may be a six digit LED readout as illustrated and is provided with a quartz or plastic lens, such as Lexan®. An audible horn control 50 activates an audible signal at the conclusion of a measurement. As in the case of module 10, portable module 40 is provided with a rechargeable battery housed behind a battery compartment door (not shown), which is held shut with latch 58, located behind a wireless antenna 56.

### Hardware Block Diagram

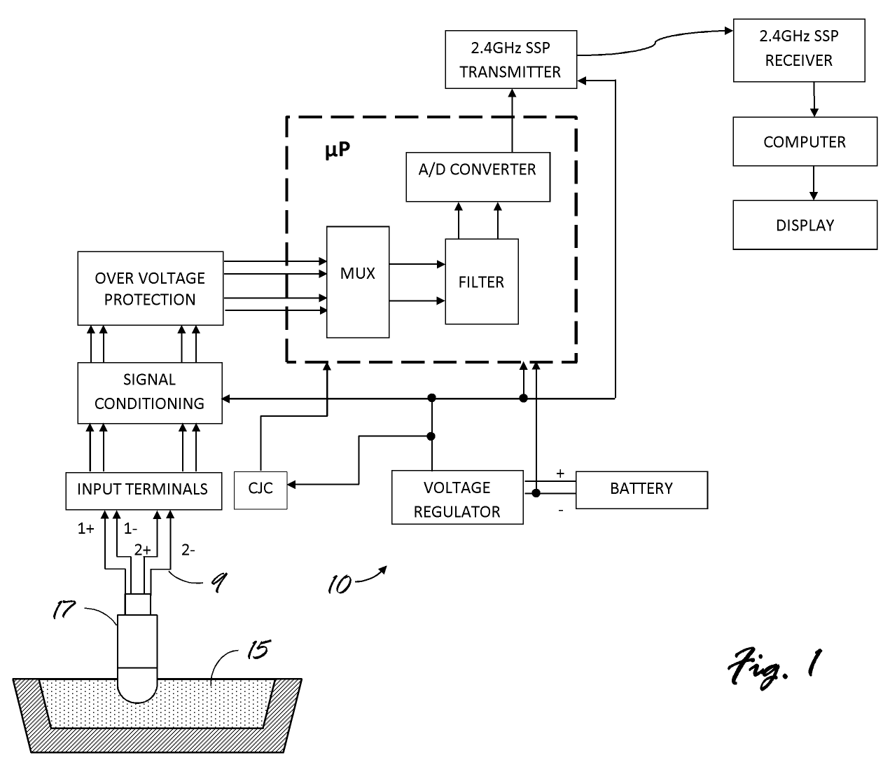

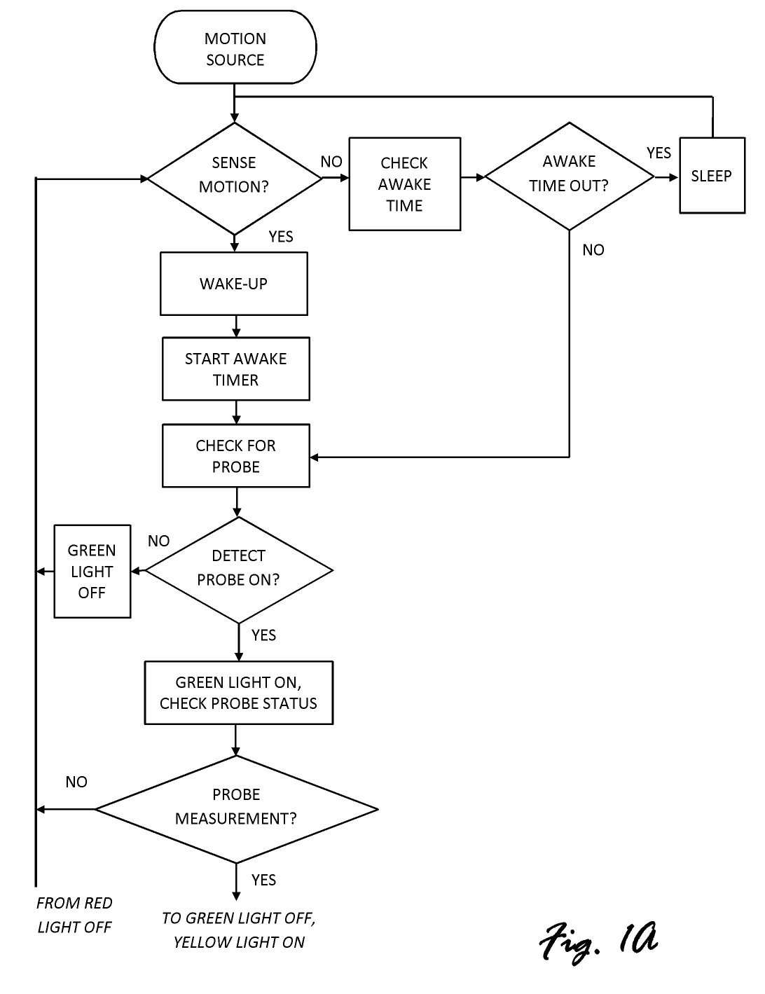

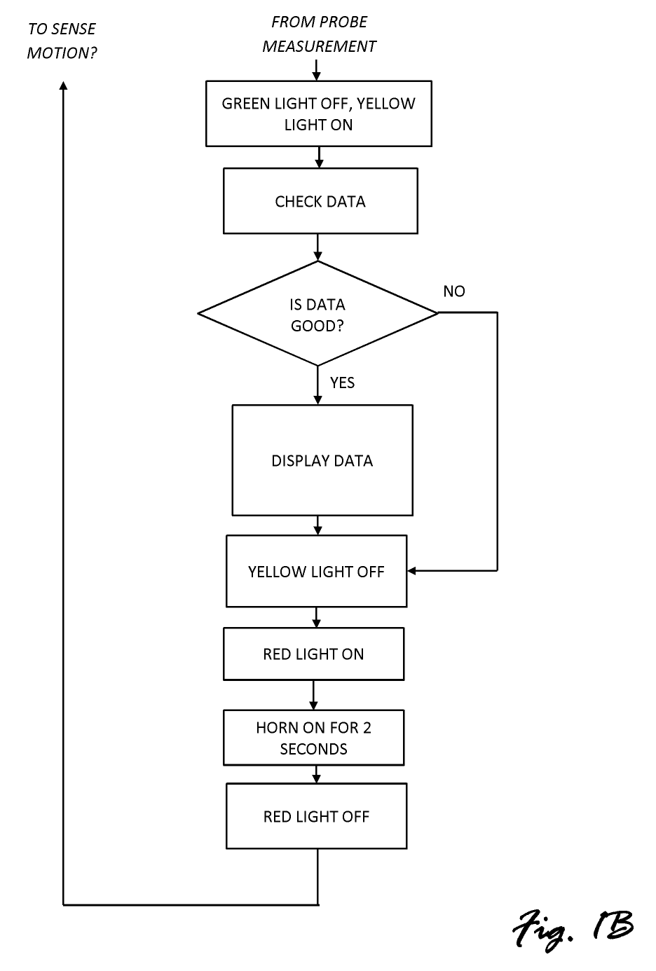

Referring to FIG. 1, there is seen a hardware block diagram showing hardware used in a preferred embodiment of the invention. Each molten metal sensor 17, when immersed in steel or iron 15, transmits analog electrical signals on wires 9, in this case four, that run through the sensor lance 20. The four wires 9 correspond to two channels, differential inputs used in this system and are denoted as 1+, 1−, 2+, and 2−. These four wires connect to the input terminals on the wireless module 10 attached to the end of the sensor lance 20. The analog signals first pass through a signal conditioning block. This signal conditioning block contains circuitry used for probe recognition and preliminary analog signal filtering. A more detailed description of the components is as follows:
(a) Probe recognition circuitry—produces a voltage that changes in a known, repeatable manner when a sensor such as a thermocouple is connected to the system.
(b) Preliminary signal filtering—low pass filter circuitry that limits the bandwidth that is able to enter the system. In this case, no frequencies over 2 kHz (two kilohertz) can pass into the system.

Once the analog signals pass through the signal conditioning block, they then proceed to an overvoltage protection block. This overvoltage protection block contains electrostatic discharge (ESD) protective elements, such as diodes that prevent high voltage spikes from damaging the system. There is also a zener diode network in place that limits maximum input voltage to 0.5V. The signals then pass into the microprocessor (μP) where they are multiplexed in the multiplexer (MUX) block, digitally filtered to remove 60 Hz (sixty hertz) noise and its harmonics in the filter block. The data are then sampled in the A/D Converter block, preferably at a rate of at least 10 times per second.

In the case of thermocouple sensors where cold junction compensation (CJC) is vital to performance, the cold junction temperature of the wireless module 10 at its input terminals is sent from the CJC block to the μP block. This is done so that the ambient temperature of the input terminals is accounted for during thermocouple measurements.

After the A/D Converter block, the now digital signal is sent to the 2.4 GHz SSP Transmitter (2.4 gigahertz spread spectrum transmitter) block where the signal is transmitted wirelessly to a 2.4 GHz SSP Receiver (2.4 gigahertz spread spectrum receiver) block. The data are then sent to a computer via a cable connection where the data are processed into an easy to understand visual form by a proprietary software program, and then shown on a display, such as an LCD monitor, the small, remote display of the invention and/or a scoreboard and signal light set.

### Software Logic Block Diagram, FIGS. 1A and 1B

The process of obtaining a measurement using the wireless system starts with wireless module 10 sensing motion from a motion source. If no motion is sensed by the wireless module 10, it will stay in a power-saving sleep mode. If motion is sensed (yes), the unit wakes-up. Once it wakes up, the unit will start an awake timer. The awake timer counts to a preset value and if it reaches said preset value before the unit detects more motion, the wireless module 10 returns to the sleep mode. If motion is present while the timer is counting, the timer will re-set until the motion discontinues.

After the wireless module 10 has awakened and entered the active mode, it begins to transmit data to the software. The software will check for probe signals on the sensor lance 20, if no probe is present, the light remains off. Then the flow of events returns to the sense motion block and repeats until the unit returns to sleep mode or a probe is put on the sensor lance. When a probe is detected, the software turns a green light on. Next, the software checks probe status to determine if there is a measurement taking place. If there is no measurement, the flow of events returns to the sense motion block.

When the software detects a probe measurement taking place, the green light turns OFF and a yellow light turns ON. The software checks the data coming into the instrument to determine if it is valid. If the data is NOT good, the yellow light turns OFF and a red light turns ON. Then a horn sounds for 2 seconds, the red light turns OFF, and the process starts over at the sense motion block. If the software determines that the data is valid, the data is displayed on the LCD monitor, the yellow light turns OFF, the red light turns ON, the horn sounds for 2 seconds, and then the red light turns OFF. The process flow then returns to the sense motion block.

### Continuous Measurement Data Acquisition Block Diagram, FIG. 1c

When interfacing the wireless data acquisition module 10 with a continuous measuring device, the process is simpler. The wireless unit that is attached to the continuous measuring device is first powered on. The unit can be powered off at any time as denoted by the dashed line going from the power on block to the power off block. After the unit is powered, it then checks to see if it detects a sensor. If no, the unit will continue checking for a sensor until one is found, or until the unit is powered off. When a sensor is detected (yes), the wireless data acquisition module 10 will transmit the data that it measures from the attached sensor. It will continue to transmit data for the term of sensor use as shown in the loop created by the detect sensor and transmit data blocks. In the continuous measurement mode, the receiving instrument detects data transmissions from the wireless unit and the operator can instruct the instrument whether to ignore the data or to receive the data. If the selection is made not to receive the data, the instrument simply does nothing until told otherwise. When the selection is made to receive the data, the instrument will display data for the time that the wireless unit transmits it, or until the operator tells the software to stop receiving.

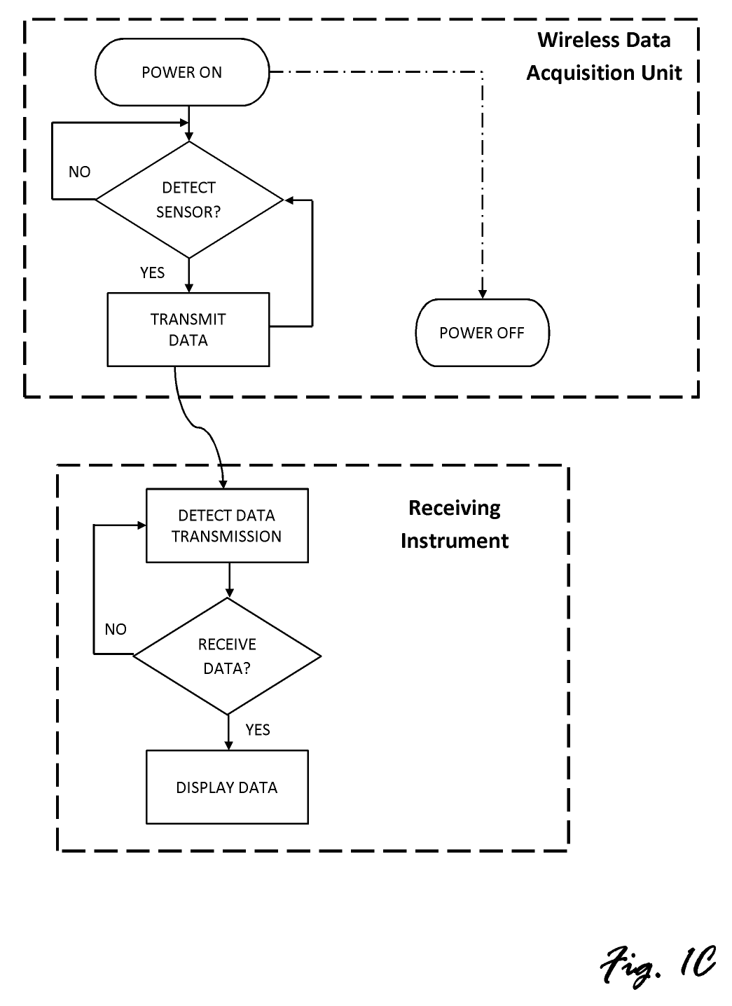

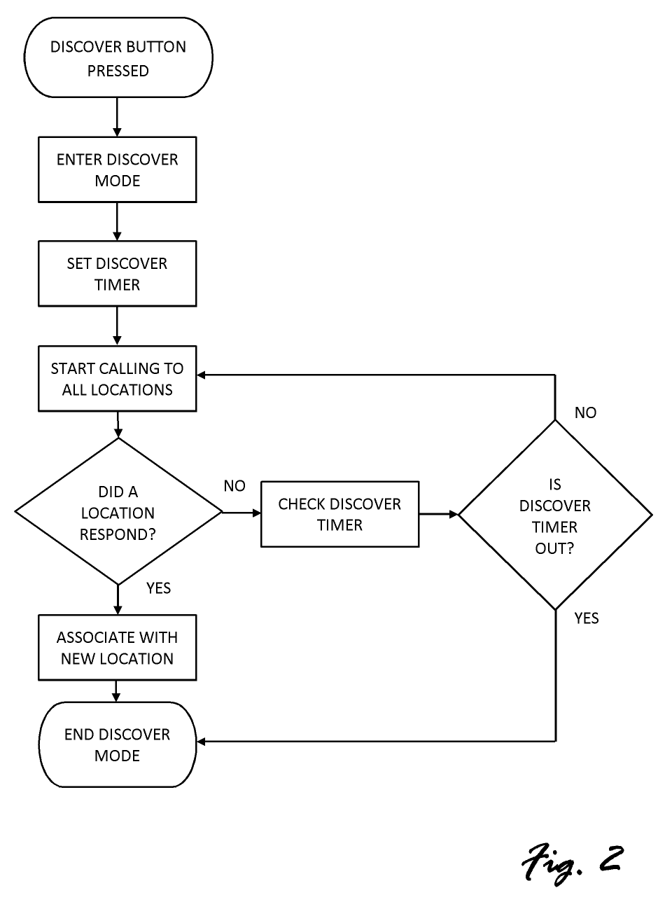

### Discovery Mode Block Diagram, FIG. 2

The process illustrated in FIG. 2 begins by pressing the discover button. The wireless module 10 then enters a discovery mode and begins counting down a timer. The unit starts signaling to all locations where compatible instrumentation is installed and waits to see if an operator at a station sends a response. If no response is sent to the wireless module 10 and the timer runs out, the module 10 ends discovery mode. If the module 10 receives a response from a new location, it will associate (pair-up) with the new location and can be used for taking measurements in a melt at that location. The module 10 then ends discovery mode.

### Data Display and Light Set Operation Block Diagram, FIGS. 2A & 2B

The process begins by placing a probe on the sensor pole (lance). If the instrument software does not detect probe on (no), nothing happens and the green light stays off. When the instrument software detects probe on (yes), the software sends a command to the remote display of the invention to turn the green light on. In the next block, if the software does not detect a probe measurement (no), the remote display green light stays on until the software detects a probe measurement (yes). When a measurement is detected, the remote display green light turns OFF and the yellow light turns ON. When the instrument software “locks on” and detects the measurement end, the remote display yellow light turns OFF, the red light turns ON, and the horn turns on for 2 seconds. Once the horn turns off, the red light turns OFF, the remote display shows the measured temperature, then the EMF (oxygen millivolts), then the oxygen content (O2 ppm), and finally the percent carbon or percent aluminum. The process begins again when another probe is placed on the pole.

1. A data recovery and display system for molten metal processing comprising a data acquisition module that is attachable to an end of a support lance said module being in electronic communication with at least one immersible probe having a sensor for obtaining analog signals identifying data of at least one characteristic of the molten metal, said module housing circuitry and a wireless transmitter and being connected to a power source, said circuitry being capable of converting said analog signals to a digital format, said transmitter being adapted sending the digital signals wirelessly to receiving circuitry, thereby communicating with circuitry in a readout instrument.

2. A system according to claim 1 wherein at least one measurement device is included in said probe, said device providing measurements of temperature, oxygen, carbon, or sulfur.

3. A system according to claim 1 wherein said power source comprises a rechargeable battery.

4. A system according to claim 1 wherein the readout instrument comprises a microprocessor having software and associated circuitry, that reads the signals, analyzes the data, controls signal lights, and displays resultant output curves.

5. A system according to claim 1 wherein the data acquisition module comprises a microprocessor.

6. A system according to claim 1 wherein the data acquisition module attaches to an end of a support lance by means of a threaded or keyed connector.

7. A system according to claim 1 wherein the data acquisition module makes electrical connection to an end of a support lance by means of male or female contacts.

8. A system according to claim 1 wherein the data acquisition module body is made of metal.

9. A system according to claim 1 wherein the data acquisition module has visual indicators for operator feedback.

10. Apparatus for measurement and display of at least one characteristic of molten metal contained in a metal processing vessel comprising a probe supported by an immersion end of a lance, said probe adapted to be submerged in the molten metal to obtain data in analog form identifying at least one characteristic of the said metal, a module connected to an end of said lance opposite from said immersion end, said module containing electronic circuitry for receiving said analog data and for converting said analog data into digital form, said module also containing electronic circuitry for transmitting said digital data wirelessly to a remotely located receiving device.

11. Apparatus according to claim 10 wherein said remotely located receiving device comprises a portable unit that includes circuitry for wirelessly receiving and interpreting said digital data and a display panel for visually displaying said data identifying said characteristic.

12. Apparatus according to claim 11 wherein said receiving device is provided with electronic circuitry for discovering whether or not another device is present in its vicinity having circuitry capable of communication with the circuitry of said receiving device.

13. Apparatus according to claim 1 wherein said circuitry is capable of monitoring electronic signals emitted continuously by said sensor.

14. Apparatus for measurement and display of at least one characteristic of molten metal contained in a metal processing vessel comprising a sensor mounted in said metal processing vessel, said sensor adapted to be submerged in the molten metal to obtain data in analog form identifying at least one characteristic of the said metal, a module connected to an end of said sensor outside of the vessel, said module containing electronic circuitry for receiving said analog data and for converting said analog data into digital form, said module also containing electronic circuitry for transmitting said digital data wirelessly to a remotely located receiving device.

15. Apparatus according to claim 11 wherein said circuitry is capable of monitoring electronic signals emitted continuously by said sensor.
